(19) United States
(12) Patent Application Publication
(10) Pub. No.: US 2014/0129386 A1
(43) Pub. Date: May 8, 2014

(54) COMPUTERIZED REAL-TIME VALUE SCORING OF VEHICLES

(71) Applicant: AUTOFUSION, INC., San Diego, CA (US)

(72) Inventors: Ahmed F. Ghouri, League City, TX (US); Roy van Beaumont, Chula Vista, CA (US)

(73) Assignee: AUTOFUSION, INC., San Diego, CA (US)

(21) Appl. No.: 13/670,171

(22) Filed: Nov. 6, 2012

(51) Int. Cl. G06Q 30/00

(52) U.S. Cl. 705/26.61

(57) ABSTRACT

Systems and methods for real-time value scoring of automobiles are described herein. In one aspect, a criterion identifying a type of vehicle is received. A number of vehicles offered for sale are identified, based at least in part on the criterion. A metric indicating the relative value of each of the identified offers for sale is provided, based at least in part on the other identified offers. The identified offers are organized based at least in part on options included on each vehicle and the metric indicating the relative value of each of the identified offers. The organized identified offers are then provided. In some implementations, the relative value metric may be generated based at least in part on the other identified offers.

### BACKGROUND

1. Field

The present application relates generally to displaying information about vehicles for sale and providing relative value metric to indicate whether a particular vehicle offered for sale is a good value, an average value, or a poor value, based, at least in part, on the price of other similar vehicles.

2. Background

Purchasing a vehicle can be a very difficult and intimidating process for buyers. Purchasing a vehicle represents a large investment and there are a wide variety of choices available to a purchaser. It can be extremely difficult for vehicle buyers to compare vehicles to each other, when there are large numbers of vehicle makes and models available, each with different features, in different locations, and with a wide variety of lease and financing options. It may be especially difficult for individuals to choose between used vehicles, as used vehicles may also have varying vehicle histories, years, warranties, and mileages, and do not have a manufacturer suggested retail price. Therefore, improved systems and methods for providing potential vehicle purchasers with real-time information about how vehicle offers compare to each other are desired.

### SUMMARY

The system described herein provides a potential vehicle buyer with a metric indicating the relative value of vehicle offers, and allows the potential vehicle buyer to easily compare vehicle offers to each other in order to make a more informed decision more quickly, and to be more confident in his/her decision. Accordingly, systems and methods that display vehicle sale information, including a metric indicating the relative value of each vehicle offer, are described. The relative value metric for a vehicle may be based, at least in part, on the price of that vehicle compared to the price of other similar vehicles within a given geographic region at that moment in time. The relative value metric may be presented to a user in a format which enables the user to quickly determine whether a given vehicle is a good value, an average value, or a poor value. These systems and methods may be valuable to a potential vehicle buyer, who may be able to quickly find and evaluate vehicles which are for sale near the potential buyer. These systems and methods may also be valuable to a potential seller, who may be able to quickly and accurately determine a price at which to sell a vehicle, and may have confidence that this price is neither too high nor too low for the local market.

The systems and methods described each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features described provide advantages that include providing a relative value metric for vehicle sale offers, to both potential buyers and potential sellers of vehicles.

### BRIEF DESCRIPTION OF THE DRAWINGS

FIG. 1 shows a functional block diagram for buying and selling vehicles including a vehicle pricing system.

FIG. 2 shows a functional block diagram of an example of a vehicle pricing system.

FIG. 3 shows a functional block diagram of an example buyer interface circuit.

FIG. 4 shows a functional block diagram of an example seller interface circuit.

FIG. 5 shows an interface diagram of an example user interface which may be generated by a vehicle pricing system.

FIG. 6 shows an interface diagram of another example user interface which may be generated by a vehicle pricing system.

FIG. 7 shows a process flow diagram of an example of a method of displaying vehicle sale information.

FIG. 8 shows a process flow diagram of an example of a method of pricing a vehicle.

FIG. 9 shows a process flow diagram of an example of determining a relative offer value for a plurality of offers.

### DETAILED DESCRIPTION

The word “exemplary” is used herein to mean “serving as an example, instance, or illustration.” Any aspect or embodiment described herein as “exemplary” is not necessarily to be construed as preferred or advantageous over other aspects or embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different communication technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

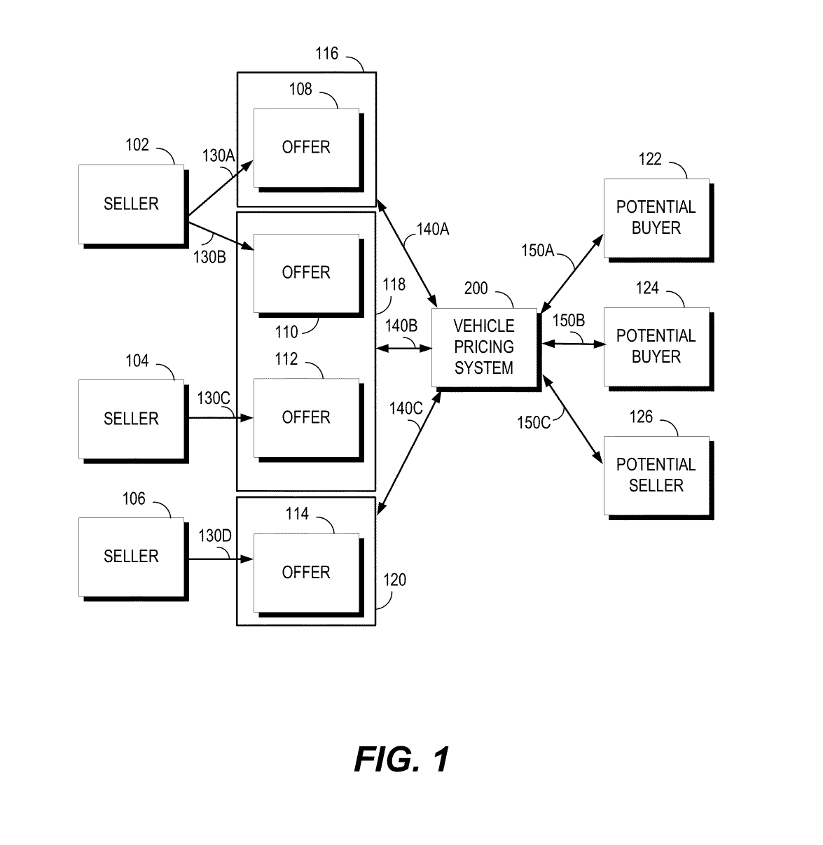

FIG. 1 shows a functional block diagram for buying and selling vehicles including a vehicle pricing system. A seller 102 may submit an offer 108 to sell a vehicle to a vehicle selling forum 116 via a communication pathway 130A. The seller 102 may be an individual or may be a professional, such as a car dealership or other vehicle seller. The vehicle selling forum 116 may include any number of websites or other locations where vehicles may be offered for sale and listed electronically. These locations may include vehicle dealership websites, Craigslist, eBay, or other locations. The communication pathway 130A may include a wired or wireless network connection including Ethernet, WiFi, cellular, satellite, or other communication mediums. For example, the seller 102 may submit the offer 108 using an electronic network, such as the Internet. The seller 102 may also submit an offer 110 to another vehicle selling forum 118 via another communication pathway 130B. The seller 102 may submit multiple offers 108, 110 to multiple vehicle selling forums 116, 118, for either the same vehicle or for different vehicles. Other sellers 104, 106 may submit offers 112, 114, to either the same vehicle selling forum 118 or other vehicle selling forums 120 via similar communication pathways as described above. Each vehicle selling forum may include one or more offers, from one or more sellers.

A vehicle pricing system 200 may collect offers 108, 110, 112, 114 from a number of vehicle selling forums 116, 118, 120. The vehicle pricing system 200 may communicate with the vehicle selling forum 116 via a communication pathway 140A. The vehicle pricing system 200 may be configured to collect an offer 108 from the vehicle selling forum 116. Each vehicle selling forum may include one or more offers, and the vehicle pricing system 200 may collect some or all of the offers found on each vehicle selling forum. The communication pathway 140A may include a wired or wireless network connection including Ethernet, WiFi, cellular, satellite, or other communication mediums. For example, the vehicle pricing system 200 may be attached to a network, such as the Internet. The vehicle pricing system 200 may use this network to connect to a vehicle selling forum 116, in order to collect an offer 108 from that vehicle selling forum 116. The vehicle pricing system 200 may be configured to connect to any number of vehicle selling forums, via a network such as the Internet.

The vehicle pricing system 200 may collect offers from vehicle selling forums in an automated manner. The vehicle pricing system 200 may be configured to collect offers from vehicle selling forums based at least in part on a schedule. For example, the vehicle pricing system 200 may be configured to collect offers from vehicle selling forums once every week, once every day, once every hour, or any other frequency. The vehicle pricing system 200 may also continuously collect offers from a number of vehicle selling forums, such that the vehicle pricing system 200 may be able to quickly collect new offers that are submitted to a number of vehicle selling forums. The vehicle pricing system 200 may be configured to continuously monitor any number of vehicle selling forums, in order to determine when new offers are posted to those vehicle selling forums, or to determine when other offers are removed. In some implementations, the vehicle selling forums may provide offer information (e.g., push) to the vehicle pricing system 200.

A potential buyer 122 may access the vehicle pricing system 200 via communication pathway 150A such as via a network (e.g., the Internet). For example, the vehicle pricing system 200 may be accessible as a web site that allows potential buyers to determine the value of individual vehicles. The vehicle pricing system 200 may be valuable to potential buyers to help them determine whether a vehicle being offered for sale is a good deal, or to determine what price they may expect to pay for certain vehicles with certain features. The vehicle pricing system 200 may therefore allow a potential buyer 122 to save time and effort in purchasing a vehicle, as the potential buyer may be able to purchase a vehicle with much more confidence that they are receiving a good deal.

A potential seller 126 may access the vehicle pricing system 200 via a communication pathway 150C such as a network (e.g., the Internet). For example, the vehicle pricing system 200 may be accessible as a web site that provides features that may aid a potential seller 126. For example, the vehicle pricing system 200 may assist a potential seller in determining the price at which to list a vehicle for sale. The vehicle pricing system 200 may also provide a potential seller 126 with an estimate of the amount of time it may take for a vehicle priced at a certain price to sell. The vehicle pricing system 200 may also provide a potential seller 126 with information related to when the seller may wish to consider lowering the price of a vehicle, or may alert a potential seller 126 if the price of a certain vehicles either rises or falls a certain amount.

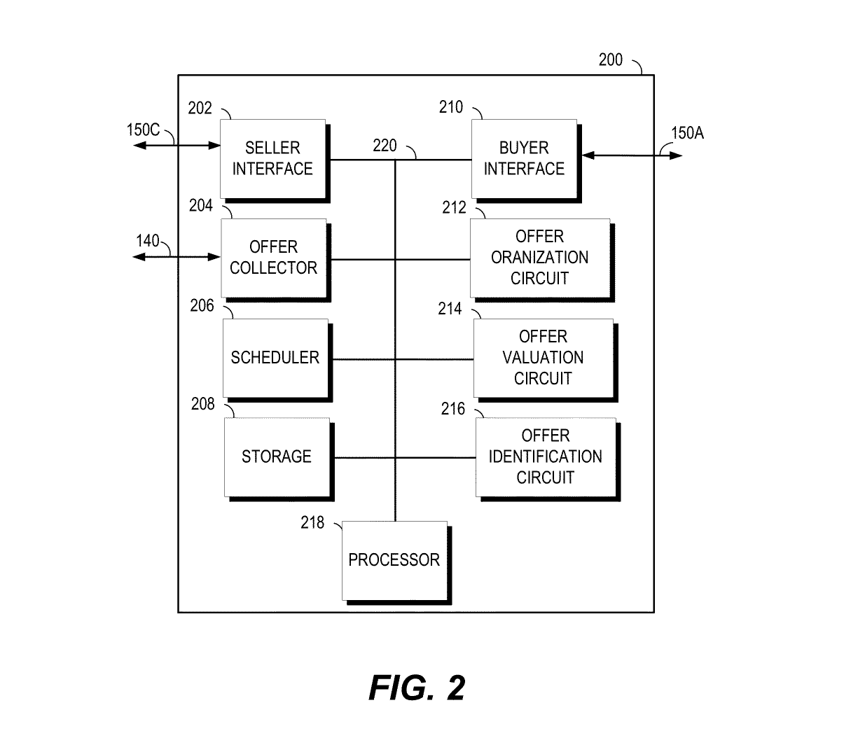

FIG. 2 shows a functional block diagram of an example of a vehicle pricing system 200. The vehicle pricing system 200 may include an offer collector 204. The offer collector 204 may access any number of vehicle selling forums via a communications pathway 140 to collect offers to sell vehicles from those vehicle selling forums. The communication pathway 140 may include a wired or wireless network connection including Ethernet, WiFi, cellular, satellite, or other communication mediums. The offer collector 204 may be attached to a network, such as the Internet, and may use the network to access vehicle selling forums in order to collect offers. The offer collector 204 may collect offers from a variety of websites via the network. For example, the offer collector 204 may collect offers from vehicles offered for sale on vehicle dealership web sites, as well as other websites such as eBay or Craigslist. The offer collector 204 may collect a variety of types of offers, including offers to sell vehicles, offers to purchase vehicles, and vehicle auctions. In some implementations the offer collector 204 may be implemented as or include a web-crawler. The offer collector 204 may be configured to access publicly-available websites, such as the websites of Craigslist or vehicle dealerships, in order to collect offers of vehicles for sale. The offer collector 204 may be configured to crawl and index these web sites according to a set schedule, and may be configured to parse the information from these websites in order to obtain offer information from these publically-available websites.

In some implementations, the offer collector 204 may obtain information from a storage 208. The information may indicate which vehicle selling forums to search, information for connecting to the vehicle selling forums (e.g., login, password, security token, URL), vehicles of interest, and the like. Based at least in part on the information, the offer collector 204 may communicate with a vehicle selling forum via the communication pathway 140. The offer collector 204 may exchange signals with the vehicle selling forum to obtain offer information. The offer collector 204 may be configured to store the obtained offer in the storage 208. In some implementations, the offer collector 204 may be configured to parse the obtained offer and store portions of the obtained offer. For example, the offer collector 204 may extract the vehicle identifier number (VIN) and the price information from an offer. In some implementations, the offer collector 204 may provide the collected offer to other elements of the vehicle pricing system 200, such as the processor 218, for further processing.

The processor 218 may be configured to process information received from the offer collector 204. The processor 218 may include or be a component of a processing system implemented with one or more processors. The one or more processors may be implemented with any combination of general-purpose microprocessors, microcontrollers, digital signal processors, or any other suitable entities that can perform calculations or other manipulations of information. The processor 218 may also include memory, which may include both read-only memory and random access memory, may provide instructions and data to the processor 218. The processor 218 typically performs logical and arithmetic operations based on program instructions stored within the memory 218. The instructions in the memory 218 may be executable to implement the methods described herein. The processor 218 may be configured to parse information that the offer collector 204 collects from vehicle selling forums, and may be configured to store this information in the storage 208. The storage 208 may include various computer components or recording media that retain information. The storage 208 may include a database, cloud data storage service, cluster shared volumes (CSV) arrangement, flat file, or other information storage file or systems.

The vehicle pricing system 200 may include a seller interface 202. The seller interface 202 may be configured to allow potential sellers access to the functions of the vehicle pricing system 200 via a communication pathway 150C such as a network (e.g., the Internet). The seller interface 202 may offer a variety of functions which may be useful to a potential seller. For example, the seller interface 202 may provide a potential seller with a price at which they might wish to list a vehicle for sale. The seller interface 202 may also provide a potential seller with an estimate of the amount of time it may take for a vehicle priced at a certain price to sell. The seller interface 202 may also provide a potential seller 126 with information related to when the seller may wish to consider lowering the price for their vehicle, or may alert a potential seller 126 if the price of certain vehicles rises or falls a certain amount. The processor 218 may be configured to access information contained within the storage 208, and to parse this information in order to provide these and other services to potential sellers.

The vehicle pricing system 200 may include a buyer interface 210. The buyer interface 210 may be configured to allow potential buyers access to various functions of the vehicle pricing system 200 via a communication pathway 150A such as a network (e.g., the Internet). For example, the buyer interface 210 may allow potential buyers to determine the price at which a particular vehicle may be a good deal or a poor deal. The buyer interface 210 may allow a potential buyer to specify at least one of his or her location, a make, a model, a year, a mileage, a transmission type, and a partial or full list of features that a potential buyer may desire in a vehicle. The buyer interface 210 may be configured to use some or all of these features to provide the buyer with information relating to prices that similar vehicles have sold for in the past, the prices at which similar vehicles for listed, and information related to what prices may constitute a good or bad value for a particular vehicle or type of vehicle. For example, a buyer interface 210 may be configured to provide a potential buyer prices at which a particular vehicle may be a great value, an average value, and/or a poor value. The buyer interface 210 may also be configured to allow a potential buyer to describe a particular vehicle that the potential buyer is interested in, including the price of that vehicle, and the buyer interface 210 may be configured to indicate to the potential buyer whether or not a certain vehicle at a certain price is a good value. The buyer interface 210 may configured to direct a potential buyer to other similar vehicles offered for sale. For example, a potential buyer may describe the features of a particular vehicle and the price of that vehicle, and the buyer interface 210 may be configured to inform the potential buyer if that particular vehicle is a good value. The buyer interface 210 may be configured to indicate to a potential buyer other similar vehicles that may be available nearby, and whether those vehicles are priced competitively. The buyer interface 210 may also be configured to indicate to a potential buyer how much more money certain features may cost on a vehicle, so that a potential buyer could determine whether to purchase a vehicle with those optional features.

The vehicle pricing system 200 may also include an offer identification circuit 216. The offer identification circuit 216 may be configured to identify one or more offers contained within the storage 208, based upon one or more parameters. The offer identification circuit 216 may be configured to receive these parameters from one or more of the buyer interface 210, the seller interface 202, or the offer collector 204. For example, the buyer interface 210 may be configured to receive one of more parameters related to a vehicle from a potential buyer. The offer identification circuit 216 may be configured to receive these one or more parameters from the buyer interface 210, and to identify one of more offers contained within the storage 208, based at least in part on the received parameters. In some embodiments, the offer identification circuit 216 may be configured to receive one or more parameters from the seller interface 202, and to identify one or more offers contained within the storage 208, based at least in part upon the received parameters. In some embodiments, the offer identification circuit 216 may be configured to receive one or more parameters from the offer collector 204, and to identify one or more offers contained within the storage 208, based at least in part upon the received parameters. For example, the offer identification circuit 216 may be configured to identify offers within the storage 208 that are similar to new offers which may be found by the offer collector 204. The offer identification circuit 216 may identify offers in a number of different ways. For example, the offer identification circuit 216 may identify offers which match the received parameters or which match some subset of the received parameters. The offer identification circuit 216 may also identify offers which are similar to the received parameters, but which may differ from the received parameters. For example, the offer identification circuit 216 may identify offers which match most of the received parameters, but where one or more of the received parameters do not match the offer. The offer identification circuit 216 may weight parameters differently, when identifying offers. For example, if the offer identification circuit 216 receives parameters from the offer collector 204, these parameters may include a price of the offer. It may be beneficial if the offer identification circuit 216 does not consider the price of the received offer when identifying other offers, as the offer identification circuit 216 may be used to compare prices of similar vehicles rather than to compare different vehicles with similar prices. Thus, it may be beneficial to assign a weight of zero to the price of a vehicle, in some embodiments. Other weights may also be used for vehicle price and other vehicle parameters. The offer identification circuit 216 may also have multiple modes for identifying offers. In some embodiments, the offer identification circuit 216 may use different weights or identify a larger or smaller number of similar offers based whether the offer identification circuit 216 is receiving parameters from the seller interface 202, the buyer interface 210, or the offer collector 204. The offer identification circuit 216 may identify offers based in part on the received parameters, but may also identify offers based on other parameters. For example, the offer identification circuit 216 may be configured to identify more recent offers more frequently than older offers.

The vehicle pricing system 200 may include an offer organization circuit 212. The offer organization circuit 212 may be configured to receive one of more offers which have been identified by the offer identification circuit 216. The offer organization circuit 212 may also be configured to receive one or more parameters from the seller interface 202, the offer collector 204, and/or the buyer interface 210. The offer organization circuit 212 may be configured to organize the one or more offers received from the offer identification circuit 216. The offer organization circuit 216 may be configured to organize offers in a number of ways. For example, the offer organization circuit may organize offers by price, proximity, date of the offer, vehicle make, model, year, features, or any number of other ways. The offer organization circuit 216 may be configured to sort orders by one or more criteria in an ascending or descending manner, or may be configured to organize offers such that the first few offers show a cross-section of the types of offers available. For example, it may be beneficial if the offer organization circuit 216 organized the identified offers such that the first few offers include vehicles with various features and at various prices. The offer organization circuit 212 may be configured to organize offers based at least in part upon the one of more parameters received the seller interface 202, the offer collector 204, or the buyer interface 210. For example, the buyer interface 210 may allow a potential buyer to organize offers using a variety of methods, such as organizing offers by relative value, by price, by location and/or proximity, by mileage on a vehicle, or any number of other criteria. The offer organization circuit 210 may be configured to receive parameters from the buyer interface 210 which correspond to a method of organizing offers. The offer organization circuit 210 may be configured to organize offers received from the offer identification circuit 216 based, at least in part, upon these received parameters.

The vehicle pricing system 200 may also include an offer valuation circuit 214. The offer valuation circuit 214 may provide a relative value for an offer, based at least in part upon offers for similar vehicles. The offer identification circuit 216 may be used to identify offers for similar vehicles, and to transmit the identified offers to the offer valuation circuit 214 via the bus system 220. The offer valuation circuit 214 may be operated in conjunction with the offer collector 204, such that when the offer collector 204 collects an offer, the offer valuation circuit 214 may provide a relative value for the collected offer. The offer valuation circuit 214 may also generate a relative value for offers similar to the collected offer, based at least in part on the collected offer. For example, if the offer collector 204 collects a new offer for a certain type of vehicle such as a Toyota Corolla, the offer valuation circuit 214 may generate a relative value for the new Toyota Corolla offer that has been collected, and may also generate a relative value for other Toyota Corolla offers that have been collected in the past and stored in the storage 208. It may be useful to generate new relative values for each similar vehicle because each relative value may be based, at least in part, upon the prices of all similar vehicles. Therefore, when a new similar vehicle is offered for the, the relative value of prior offers may change due to the new similar vehicle offer. The offer valuation circuit 214 may also be configured to run automatically and/or according to a certain schedule by the scheduler 206.

In some implementations, the offer valuation circuit 214 may obtain information regarding an offer from the storage 208 or from the offer collector 204. For example, the offer collector 204 may communicate, via an electronic device, with a vehicle selling forum. The offer collector 204 may collect, via the electronic device, an offer from the vehicle selling forum. The offer collector 204 or the offer valuation circuit 214 may extract vehicle attributes from the collected offer. These vehicle attributes may include details about a vehicle for sale, such as VIN, year, make, model, location, mileage, price, and other information. The offer valuation circuit 214 may transmit the collected offer and/or the vehicle attributes from the collection offer to the offer identification circuit 216. In some implementations, the offer valuation circuit 214 and/or the offer collector 204 may be configured to operate in real time (e.g., without intentional delay, given the processing limitations of the system and the time required to accurately acquire the data).

The offer identification circuit 216 may access the storage 208 via the bus system 220, in order to identify a number of comparison offers for similar vehicles. The storage 208 may contain vehicle attributes associated with a plurality of vehicles offered for sale. For example, the offer identification circuit 216 may identify one or more comparison offers from the plurality of vehicles offered for sale, based at least in part on the vehicle attributes associated with the collected offer and the vehicle attributes associated with the comparison offers. The offer identification circuit 216 may identify a large or small number of comparison offers. The offer identification circuit 216 may search for and identify comparison offers that are a close match to the collected offer, such as comparison offers for vehicles with very similar makes, models, years, mileages, features, and in nearby locations. The offer valuation circuit 214 may receive the identified comparison offers, and may generate a metric indicating a relative value of the collected offer, based at least in part on vehicle attributes associated with the collected offer and the identified comparison offers. For example, the offer valuation circuit 214 may implement a mathematical algorithm in order to compare the vehicle attributes, such as price and features, of the collected offer to the vehicle attributes of the identified comparison offers, in order to generate a metric indicating a relative value of the collected offer. This relative value metric may take a number of forms, such as being a number between 0 and 100, where 100 is the best value available. The offer valuation circuit 214 may also determine a relative value metric for one or more of the identified comparison offers, as the relative value metric for the identified comparison offers may change due to the addition of the collected offer. The offer valuation circuit 214 may be configured to operate in conjunction with the offer collector 204 when a new offer is found. The offer valuation circuit 214 may also be configured to operate in conjunction with the seller interface 202 and/or the buyer interface 210, in order to determine a relative value metric for an offer that may be displayed by these interfaces. The offer valuation circuit 214 may also be configured to operate according to a schedule determined by the scheduler 206. The offer valuation circuit 214 may also be configured to operate if an offer is removed from the storage 208. For example, it may be beneficial to remove offers that are no longer listed on a vehicle selling forum, or which are a certain age, as it may be undesirable to include a large number of outdated offers in the vehicle pricing system 200. If an offer is removed from stored, it may be beneficial to use the offer valuation circuit 214 to determine new relative value metrics for offers similar to the removed offer, as the relative value metric for these similar offers may change due to the removal of the removed offer.

The scheduler 206 may be configured to schedule and/or automate functions of the vehicle pricing system 200, including the operation of the offer collector 204, the operation of the offer valuation circuit 214, the maintenance of the storage 208, and other functions. The scheduler 206 shown may allow the various functions of the vehicle pricing system 200 to be triggered such as by date, system event (e.g., appearance of a file on the file system), email, or text message. The scheduler 206 may include conditions which must be satisfied before a function may begin such as adequate disk space, idle processor time, or presence of a data file. The scheduler 206 may be further configured to report status of a scheduled function (e.g., start, stop, errors) such as via email, text message, voice message, or event log.

For example, the scheduler 206 may be triggered to initiate the offer collector 204 at some specific date and time. For example, it may be found that it is beneficial to operate the offer collector 204 at a time when the vehicle pricing system 200 is least busy, such as during the night. The scheduler 206 may be configured to initiate the offer collector 204 at a particular time on one or more particular days of the week. In some embodiments, the scheduler 206 may be configured to monitor a metric of how busy the vehicle pricing system 200 is, and to initiate the offer collector 204 when the system falls below a certain threshold of use. For example, the scheduler 206 may monitor CPU usage, number of user sessions, amount of activity in the storage 208, amount of network usage and/or other indicators of how busy the vehicle pricing system 200 is at any given time. The scheduler 206 may initiate the offer collector 204 to collect offers from all vehicle selling forums, or may direct the offer collector 204 to collect offers from only one or more vehicle selling forums. For example, the scheduler 206 may store information on the storage 208 which may be accessed by the offer collector 204, and may indicate which vehicle selling forums to collect offers from. The scheduler 206 may also schedule the offer collector 204 to collect offers from different vehicle selling forums more or less frequently. For example, the scheduler 206 may be configured to determine the number of new offers which are found on a given vehicle selling forum each time the offer collector 204 collects offers from the vehicle selling forum. The scheduler 206 may store the time of the collection and the number of offers collected in the storage 208. The scheduler 206 may use this information, at least in part, to determine how often the offer collector 204 collects offers from a given vehicle selling forum. For example, if the scheduler 206 finds that a certain vehicle selling forum more frequently contains new offers of vehicle for sale, the scheduler 206 may more frequently initiate the offer collector 204 to collect offers from that vehicle selling forum. The scheduler 206 may also initiate the offer collector 204 to collect offers from more vehicle selling forums during times when the system is less busy, and may initiate the offer collector 204 to collect offers from fewer vehicle selling forums at times when the vehicle pricing system 200 is busier. The scheduler 206 may also initiate certain maintenance tasks, such as maintaining the storage 208, according to system usage, and whether or not the system is busy.

The various components of the vehicle pricing system 200 may be coupled together by a bus system 220. The bus system 220 may include a data bus, for example, as well as a power bus, a control signal bus, and a status signal bus in addition to the data bus. Those of skill in the art will appreciate the components of the vehicle pricing system 200 may be coupled together or accept or provide inputs to each other using some other mechanism.

Although a number of separate components are illustrated in FIG. 2, those of skill in the art will recognize that one or more of the components may be combined or commonly implemented. For example, the processor 218 may be used to implement not only the functionality described above with respect to the processor 218, but also to implement the functionality described above with respect to the seller interface 202, the buyer interface 210, the offer collector 204 and/or other components of the vehicle pricing system 200. Further, each of the components illustrated in FIG. 2 may be implemented using a plurality of separate elements.

Moreover, components or the entirely of the vehicle pricing system 200 may be programmed using various coding languages such as C-Sharp or C++, via a framework such as Microsoft Visual Studio.

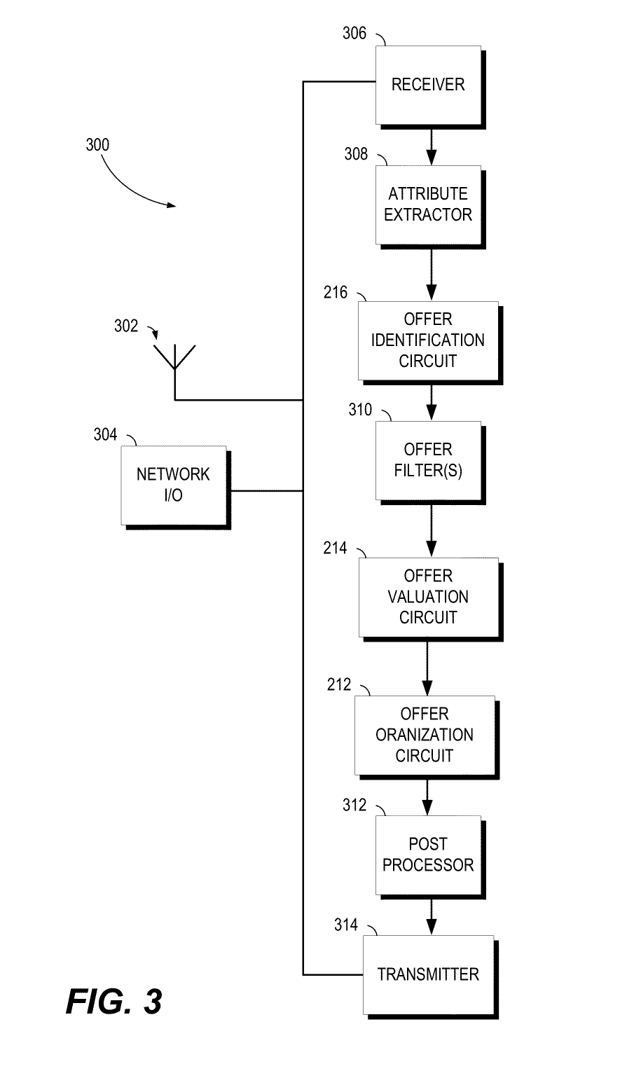

FIG. 3 shows a functional block diagram of an example buyer interface circuit 300. The buyer interface circuit 300 may include a network input/output 304. The network input/output 304 may be configured to provide the buyer interface circuit 300 access to a network (e.g., the Internet). The buyer interface circuit 300 may also include an antenna 302. The antenna 302 may be configured to provide the buyer interface circuit 300 wireless access to a network (e.g., the Internet). The antenna 302 may be any type of antenna, and may be configured to access a wide variety of wireless networks. For example, the antenna 302 may be configured to access a wireless network such as a WiFi network, satellite network, or cellular network, such as a GSM, HSPA+, or 4G LTE network.

The antenna 302 and/or network input/output 304 may be operably attached to a receiver 306. The receiver 306 may be configured to receive a criterion from potential vehicle buyers through the network input/output 304 and/or the antenna 302. The receiver 306 may be configured to receive the criterion from potential vehicle buyers in a large number of formats. For example, the receiver 304 may be configured to receive criterion including a number of attribute-value pairs. In some embodiments, these attribute-value pairs may be generated by a potential buyer clicking interactive items on a website or submitting a form on a website. One or more of these attributes may describe a type of quality a vehicle may have. For example, the receiver 302 may be configured to receive attributes including vehicle year, make, model, mileage, location, transmission type, features, and/or price. The receiver 302 may be configured to receive any number of values for each attribute. For example, the receiver 302 may be configured to receive zero, one, or multiple values for each attribute. For example, if the attribute in question is a vehicle year, a potential buyer may desire a vehicle from a specific year, may desire a vehicle from a certain range of years, or may by ambivalent about the year of the vehicle. Accordingly, the receiver 302 may be configured to receive an attribute-pair related to vehicle year, where the value may be a single year, multiple years, or zero years.

The buyer interface circuit 300 may include an attribute extractor 308, which may extract information from the criterion that is received by the receiver 302. In some embodiments, extracting information from the criterion may include extracting attribute-value pairs from the criterion. The attribute extractor 308 may be configured to extract the values from the attribute-value pairs received by the receiver 302, and may convert this information into a useful form. The attribute extractor 308 may be configured to receive any number of attribute-value pairs from the receiver 302. Each of these attribute-value pairs may include a single value, multiple values such as a range of values, or no values. Each attribute-value pair may refer to a unique attribute, or there may be multiple attribute-value pairs related to the same attribute. Attribute-value pairs may refer to characteristics of a vehicle, such as price, year, make, model, and transmission type, or may refer to other things, such as a preferred method of organizing the results.

The buyer interface circuit 300 may include an offer identification circuit 216, which may be configured to receive information from the attribute extractor 308. In some embodiments, this information may comprise attributes and values. The offer identification circuit 300 may be configured to access a storage containing a plurality of offers. The offer identification circuit 216 may be configured to identify one or more offers from this plurality of offers, based at least in part on the attributes and values received from the attribute extractor 308. For example, the offer identification circuit 216 may identify one or more offers which match one of more of the values for each attribute-value pair received by the attribute extractor 308. The offer identification circuit 218 may also be configured to identify offers which are similar, in some way, to the information received from the attribute extractor 308. For example, it may be useful to identify offers that are very similar to a vehicle described by a potential buyer, even if that vehicle is not an exact match. An offer identification circuit 216 may be configured to first look for exact matches, but if an insufficient number of exact matches are found, to look for similar vehicles. The offer identification circuit 216 may be configured to give differing weights to different attributes and values. The offer identification circuit 216 may also be configured to give no weight to or ignore certain attributes and values. For example, the receiver 306 may receive an attribute and value related to how a potential buyer would like to sort the offers. The offer identification circuit 216 may ignore this attribute and value, as it may not be relevant to determining which offers are similar or identical to the type of vehicle the potential buyer is interested in.

The buyer interface circuit 300 may include one or more offer filters 310, which may be configured to receive the one or more identified offers from the offer identification circuit 216. The one or more offer filters 310 may be further configured to receive the attributes and values from the attribute extractor 308 or from the offer identification circuit 216. The one or more offer filters 310 may be configured to filter offers from the one of more identified offers. This filtering may be based in part upon the attributes and values, or may be based on other criteria. For example, it may be advantageous to filter out offers based upon the date the offer was last accessed by an offer collector. It may be beneficial to filter out old or outdated offers, in order to provide a potential buyer with the most up-to-date information possible. These and other methods may be used to filter the one or more identified offers.

The buyer interface circuit 300 may have an offer valuation circuit 214, which may be configured to receive one or more filtered offers from the one of more offer filters 310. The offer valuation circuit 214 may be configured to provide a relative value for one of more of the filtered offers. The offer valuation circuit 214 may be configured to generate a relative value for one or more of the filtered offers based, at least in part, on other filtered offers. This relative value may be configured to represent whether a certain vehicle offer is a good value or a poor value, relative to other offers for similar vehicles. For example, the offer valuation circuit 214 may group the filtered offers into certain groups, such as groups based upon the features offered on different vehicles. The offer valuation circuit 214 may then compare the prices, features, and other attributes of certain vehicles in the same group, and may create a metric to reflect the relative value of each of the filtered offers. The offer valuation circuit 214 may use any number of groups. For example, the offer valuation circuit 214 may create a group of a class of vehicle, such as cars. The offer valuation circuit 214 may also group vehicles into much smaller and more specific groups, such as grouping by make, model, vehicle year, and/or features. For example, the offer valuation circuit 214 may group together all 2010 Toyota Corolla sedans with four doors and a certain number of optional features. The relative value metric provided by the offer valuation circuit 214 may take any number of forms. For example, this relative value metric may take the form of a number from between 1 and 100, where “100” may represent the best value, and “1” may represent the worst value.

The buyer interface circuit 300 may have an offer organization circuit 212, which may be configured to receive one or more filtered offers from the one of more offer filters 310. The offer organization circuit 212 may be configured to organize the filtered offers in any number of ways. For example, the buyer interface circuit 300 may provide a potential buyer with a method to sort the offers, such as allowing a buyer to sort offers from low price to high, or to sort offers according to their mileage, location, make, model, year, or other characteristic. Accordingly, the offer organization circuit 212 may be configured to organize offers according to this preference. The offer organization circuit 212 may be configured to receive a potential buyer's preferred method of sorting directly, or the preferred method of sorting may be received as an attribute-value pair by the receiver 306, and extracted by the attribute extractor 308. The offer organization circuit 212 may also have a default method of organizing offers, if a potential buyer has not indicated a preferred method of sorting the offers. The offer organization circuit 212 may, for example, sort offers such that a potential buyer will see a representative cross-section of offers from the one of more filtered offers. It may be beneficial to show a cross-section of representative vehicles to a potential buyer in order to demonstrate to the buyer the range of vehicles available, and the prices at which various vehicles are sold. The offer organization circuit 212 may also sort the offers in other ways, such as by the relative value of each filtered offer, or by how recently each filtered offer was posted.

The buyer interface circuit 300 may have a post processor 312, which may be configured to receive one or more organized offers from the offer organization circuit 212. The post processor 312 may handle a variety of functions. For example, the post processor 312 may convert the list of organized offers into a more usable form for a potential buyer. For example, if the buyer interface circuit 300 is accessible to a potential buyer in the form of a website on the Internet, the post processor 312 may format the organized offers into an HTML document in order to allow the HTML document to be received by a potential buyer via an Internet browser. The post processor 312 may also perform a number of other functions, such as breaking the organized offers up into two of more pages. For example, if the post processor 312 receives a large number of organized offers from the offer organization circuit 212, it may be beneficial to break this number into individual pages of, for example, 10 offers per page. This may allow a potential buyer to browse the organized offers more easily.

The buyer interface circuit 300 may have a transmitter 314, which may be configured to receive the processed organized offers from the post processor 312. The transmitter 314 may be configured to communicate with the network input and output 304 and/or the antenna 302. This may allow the transmitter 314 to communicate with a network, such as the Internet. The transmitter 314 may be configured to transmit the processed organized offers to a potential buyer, through the network input and output 304 and/or the antenna 302. For example, if the buyer interface circuit 300 may be accessed as a website, the transmitter 314 may be configured to allow a potential buyer to view the processed organized offers in the form of a web page using a web browser connected to the Internet. Alternatively, the transmitter 314 may be configured to transmit the processed organized offers through the network input and output 304 and/or the antenna 302 to another circuit or system, which may be configured to further process the processed organized offers.

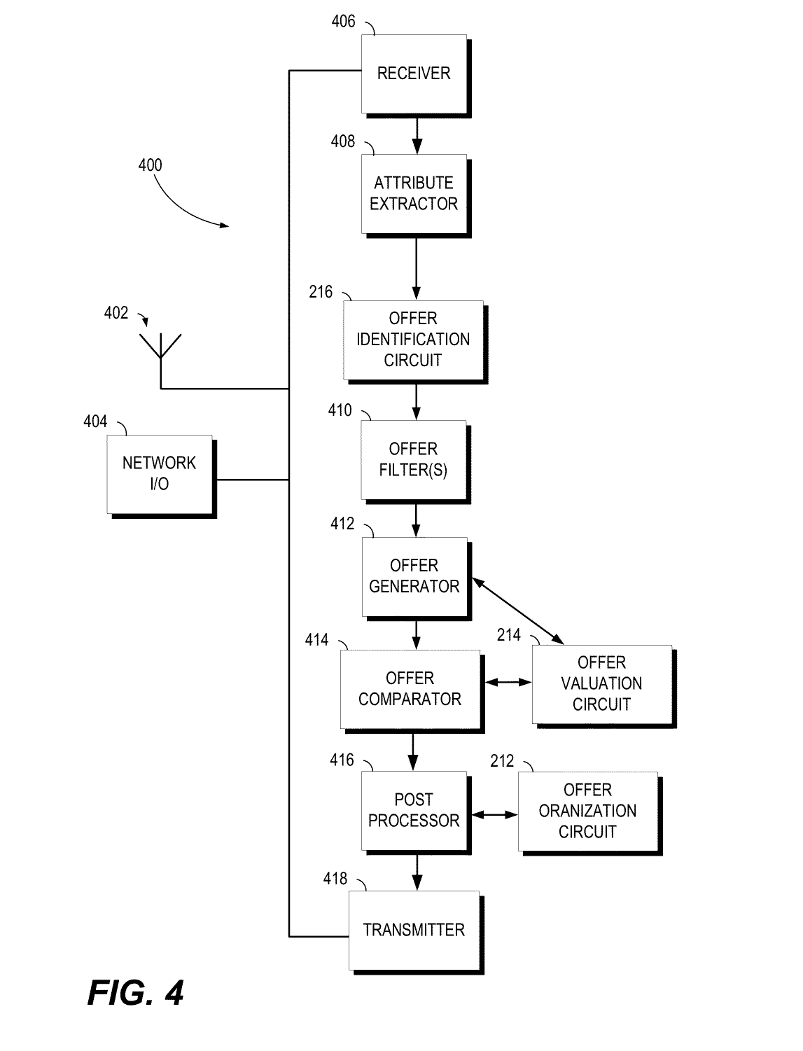

FIG. 4 shows a functional block diagram of an example seller interface circuit 400. The seller interface circuit 400 may allow a potential seller to price a vehicle appropriately. The seller interface circuit 400 may include a network input/output 404 and/or an antenna 402. The network input/output 404 and/or the antenna 402 may allow the seller interface circuit 400 access to a network, such as the Internet. The antenna 402 may be any type of antenna, and may be configured to access a wide variety of networks. For example, the antenna 402 may include a cellular antenna, configured to access a cellular network, such as a GSM, HSPA+, or 4G LTE network.

The seller interface circuit 400 may include a receiver 406. The receiver 406 may be configured to receive a criterion from potential vehicle sellers through the network input/output 404 and/or the antenna 402. The receiver 406 may be configured to receive the criterion from potential vehicle sellers in a large number of formats. For example, the criterion may include a number of attribute-value pairs. An attribute may describe a type of quality a vehicle may have. For example, a receiver 406 may be configured to receive attributes including vehicle year, make, model, mileage, location, features, or price.

The seller interface circuit 400 may have an attribute extractor 408, which may extract attribute-value pairs from the criterion that is received by the receiver 406 from a potential seller. The attribute extractor 408 may be configured to extract the values from the attribute-value pairs received by the receiver 406, and may convert these values into a useful form. The attribute extractor 408 may be configured to receive any number of attribute-value pairs from the receiver 406. For example, an attribute extractor 408 may be configured to extract attributes including vehicle year, make, model, mileage, location, features, or price. The extracted attributes may describe a vehicle that a potential seller wishes to sell.

The seller interface circuit 400 may have an offer identification circuit 216, which may be configured to receive attributes and values from the attribute extractor 408. The offer identification circuit 216 may be configured to access a storage containing a plurality of offers. The offer identification circuit 216 may be configured to identify one or more offers from this plurality of offers, based at least in part on the attributes and values received from the attribute extractor 408. For example, the offer identification circuit 216 may identify one or more offers which match one of more of the values for each attribute-value pair received by the attribute extractor 408. The offer identification circuit 216 may also be configured to identify offers which are similar, in some way, to the attributes and values received from the attribute extractor 408. For example, it may be useful to identify offers that are very similar to a vehicle described by a potential seller, even if that vehicle is not an exact match. An offer identification circuit 216 may be configured to first look for exact matches, but if an insufficient number of exact matches are found, to look for similar vehicles. The offer identification circuit 216 may be configured to assign different weights to different attributes. For example, the offer identification circuit 216 may assign no weight to price of a vehicle, as the offer identification circuit 216 may attempt to find similar vehicles regardless of whether their price is similar.

The seller interface circuit 400 may have one or more offer filters 410, which may be configured to receive the one or more identified offers from the offer identification circuit 216. The one or more offer filters 410 may be further configured to receive the attributes and values from the attribute extractor 408 or from the offer identification circuit 216. The one or more offer filters 410 may be configured to filter offers from the one of more identified offers. This filtering may be based in part upon the attributes and values, or may be based on other criteria. For example, it may be advantageous to filter out offers based upon the date at which they were created or were last accessed by an offer collector. It may be beneficial to filter out old or outdated offers, in order to provide a potential seller with the most up-to-date information. How many offers are filtered out due to date may depend, at least in part, upon the attributes and values received by the receiver 406. For example, it may be found that prices for newer vehicles fluctuate more frequently, and older prices may be of less relevance. It may also be found that, if a vehicle is infrequently offered for sale, older prices may be more relevant to evaluating more recent offers as there may be few other offers. The one or more offer filters 410 may use these and other methods to filter the one or more identified offers.

The seller interface circuit 400 may have an offer generator 412, which may be configured to receive the extracted attributes from the attribute extractor 408 and to receive the filtered offers from the one or more offer filters 410. The offer generator 412 may be configured to generate one or more potential offers based, at least in part, on the extracted attributes and/or the filtered offers. For example, if a potential seller does not propose a price for a vehicle, the offer generator 412 may be configured to generate one or more prices that the vehicle may be sold at. These prices may be based, at least in part, upon the prices at which other similar vehicles are being offered for sale, the prices at which other similar vehicles have recently sold for, or based upon other factors. It may be beneficial to generate more than one price, in order to provide a potential seller with a range of options and provide information about those options. For example, it may be beneficial to provide a potential seller with two or more prices, and to provide a potential seller with a relative value for each possible price, or to provide a seller with an estimate of how long it may take to sell a vehicle at each price.

The seller interface circuit 400 may have an offer comparator 414, which may be configured to receive the one or more offers from the potential seller. The offer comparator 414 may receive offers generated by the offer generator 412, and/or may receive offers which the receiver 406 received from the potential seller. The offer comparator 414 may also be configured to receive the one or more filtered offers from the one of more offer filters 410. The offer comparator 414 may compare the one or more offers from the potential seller to previous offers, such as the filtered offers. This comparison may take a number of forms. For example, the offer comparator 414 may attempt to determine how long it may take to sell a vehicle at a certain price, based at least in part upon the filtered offers.

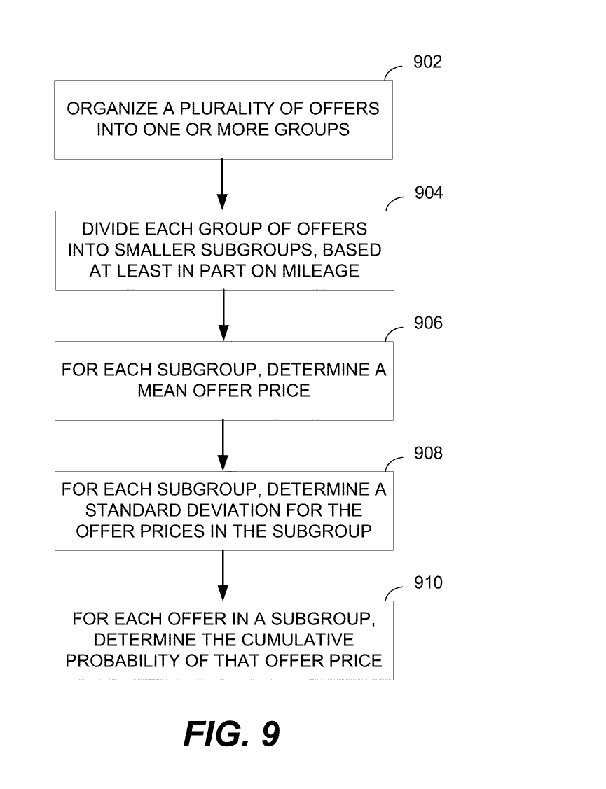

The seller interface circuit 400 may have an offer valuation circuit 214, which may be configured to receive information from the offer comparator 414. For example, the offer valuation circuit 214 may be configured to receive the one of more offers from the potential seller, and may be configured to receive the one or more filtered offers. The offer valuation circuit 214 may be configured to provide a relative value metric for the one of more offers from the potential seller, based at least in part upon the filtered offers. This relative value metric may be configured to represent whether a certain vehicle offer is a good value or a poor value, relative to other vehicle offers for similar vehicles. For example, the offer valuation circuit 214 may compare one or more extracted attributes from the attribute extractor to the one of more filtered offers. The offer valuation circuit 214 may then determine a relative value of the vehicle described by the extracted attributes, based upon the prices that other vehicles are offered for sale, based upon data contained within the filtered offers. The metric provided by the offer valuation circuit 214 may take any number of forms. For example, this relative value metric may take the form of a number from between 0 and 100, where “100” may represent the best value, and “1” may represent the worst value. For example, the relative value metric may be an integer value between 0 and 100, where the integer value represent the percentage of similar offers that a particular offer is better than. In one embodiment, for example, a relative value metric of “90” may indicate that an offer to sell a vehicle is listed at a price that is better than 90% of other similar offers. One method for how a relative value metric may be determined is contained below, in the discussion of FIG. 9.

This relative value metric may be extremely beneficial for a user who is comparing a large number of vehicles, in order to purchase a vehicle. Purchasing a vehicle, especially a used vehicle, may be a daunting process for a user, as there may be a very large number of vehicles with may vary quite a bit in features and in price. A relative value metric may help such a user to quickly determine which vehicles may represent a good value compared to other similar offers.

The offer generator 412, offer valuation circuit 214, and offer comparator 414 may be configured to work together in order to generate offers that satisfy certain criteria. For example, the offer generator 412 may attempt to generate offers that may receive a certain relative value metric. The offer generator 412 may generate one of more potential offers, and the offer valuation circuit 214 may be configured to generate a relative value metric for each of these potential offers. The seller interface circuit 400 may be configured to compare the relative value metric for each of these potential offers to a desired relative value metric. If the relative value metric for each of these potential offers varies from the desired relative value metric by a certain amount, the offer generator 412 may be configured to generate a new offer, based at least in part on the previous potential offer and on the relative value metric of that offer. In this way, the offer generator 412, offer valuation circuit 414, and offer comparator 214 may work together in an iterative manner to generate offers to aid a potential seller. For example, the seller interface circuit 400 may generate relative value metrics on a scale of “1” to “100,” and may be configured to generate an offer that would receive a relative value metric of “50.” The offer generator 412 may first generate a potential offer based upon the filtered offers. For example, the offer generator 412 may generate a first potential offer that is the mean or median of the price of the filtered offers. This first potential offer may then be given a relative value metric by the offer valuation circuit 214. If this relative value metric is insufficiently close to “50,” the offer generator 412 may generate a second potential offer, based at least on the first potential offer and the relative value metric of the first potential offer. This process may be an iterative process that may occur two or more times, until a potential offer with the desired relative value metric is obtained. The seller interface circuit 400 may also generate relative value metrics on a percentage scale. For example, the seller interface circuit 400 may generate offers that are better than 25%, 50%, 75%, or some other percentage of other offers.

The seller interface circuit 400 may have a post processor 416, which may be configured to receive one or more potential offers from the offer generator 412 or offer comparator 414. The post processor 416 may be further configured to receive one or more filtered offers. The post processor 416 may handle a variety of functions. For example, the post processor 416 may convert the one or more potential offers and/or the one or more filtered offers into a more useful form for a potential seller or for another system or circuit. For example, in the instance where a potential seller accesses the seller interface circuit 400 over the Internet via an Internet browser, the post processor 416 may format the potential offers and/or the filtered offers into an HTML document in order to allow the HTML document to be transmitted to and receive by the potential seller via an Internet browser. The post processor 416 may also perform a number of other functions, such as breaking the filtered offers up into two of more pages. For example, if the post processor 416 receives a large number of filtered offers, it may be beneficial to break this number into individual pages of, for example, 10 offers per page. This may allow a potential seller to more easily view the offers that are being used, at least in part, to provide the potential seller with an estimate of a price to sell a vehicle.

The seller interface circuit may have a transmitter 418, which may be configured to receive processed potential offers and/or processed filtered offers from the post processor 416. The transmitter 418 may be configured to transmit information using the network input/output 404 and/or the antenna 402. This may allow the transmitter 408 to communicate with an outside network, such as the Internet. The transmitter 418 may be configured to transmit the processed potential offers and/or processed filtered offers to a potential seller, through the network input/output 404 and/or the antenna 402. For example, if the seller interface circuit 400 is configured to operate a website, the transmitter 418 may be configured to allow a potential buyer to view the processed organized offers in the form of a web page using a web browser connected to the Internet. The transmitter 418 may also be configured to transmit the processed potential offers and/or processed filtered offers to another circuit or system.

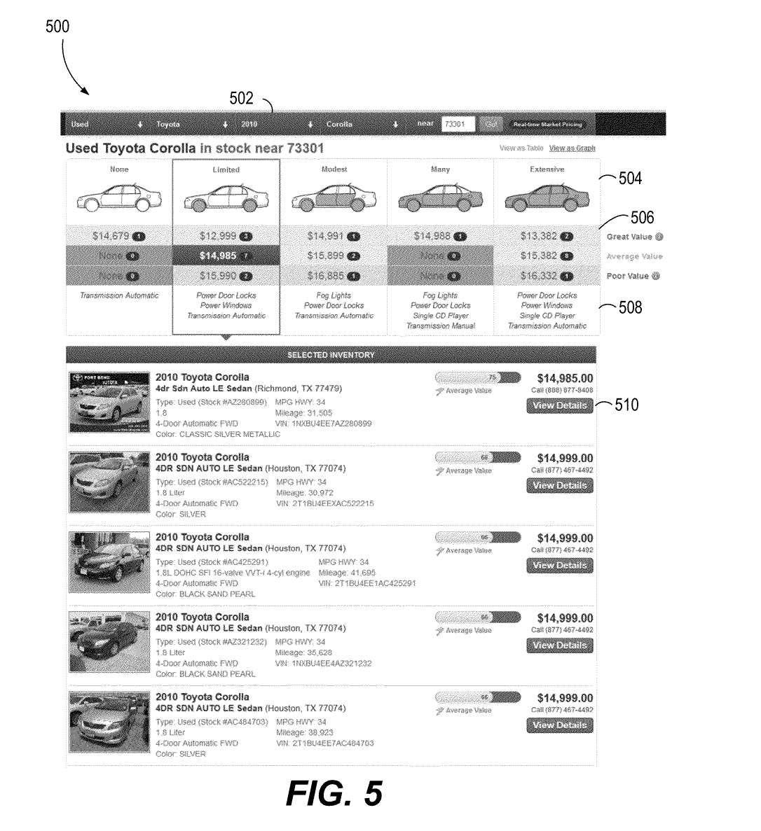

FIG. 5 shows an interface diagram of an example user interface 500 which may be generated by a vehicle pricing system. This example shows an example embodiment of a buyer interface. In this embodiment, the buyer interface may be accessed by a potential buyer in the form of a web page. This web page may be delivered over a network, such as the Internet, and may be loaded using an Internet browser. In this example user interface 500, a potential buyer has used the drop-down menus 502, or another method, to search for a used 2010 Toyota Corolla, near the ZIP code 73301. The example user interface 500 has thus returned a listing of 2010 Toyota Corollas within some distance of this location.

In this example user interface 500, the interface has grouped 2010 Toyota Corollas into groups 504 based upon the features of each vehicle: none, limited, modest, many, or extensive. This example user interface 500 has also provided a description 508 of the types of features available on vehicles in these groups 504. For example, vehicles with limited features may have power door locks, power windows, and an automatic transmission. Within each of these groups 504, the example user interface 500 may provide information on pricing in a pricing bar 506. The pricing bar 506 may provide an estimate of what prices might constitute a great value, an average value, and a poor value, for vehicles in a particular group 504. These estimates may be based, at least in part, upon a relative value metric assigned to each vehicle within a certain group. The pricing bar 506 may also indicate the number of vehicles available in each group 504. For example, among 2010 Toyota Corollas with limited features, $14,985 may represent an average value, and there may be 7 vehicles available which are an average value.

In this example user interface 500, a user may have the ability to view a number of available offers for vehicles matching the search criteria in a vehicle listing 510. The user may also have some ability to control which vehicles are shown. For example, the user may be able to narrow the view to only show vehicles with limited features. The user may also be able to narrow the view to show, for example, only vehicles with limited features that are an average value. This may be beneficial to a user for two reasons. First, the ability to view offers for vehicles within a certain range may allow a user to find a vehicle to purchase. Second, the ability to view these offers may enable a user to be more confidant in the relative value of vehicles of each type, as it may offer the user to see the offers than were used to determine the value of a certain vehicle.

Which vehicles are listed in the vehicle listing 510 may be based, at least in part, upon the user's search and based upon the user's selections, such as choosing vehicles with limited features that are an average value in the pricing bar 506. The vehicle listing 510 may list a variety of features each vehicle has, such as mileage, transmission type, location, make, model, and year. Each vehicle in the vehicle listing 510 may also include a price and/or a picture. For each vehicle in the vehicle listing 510, a relative value metric may be displayed. This relative value metric may indicate to a user whether or not a vehicle is a good value compared to other vehicles for sale.

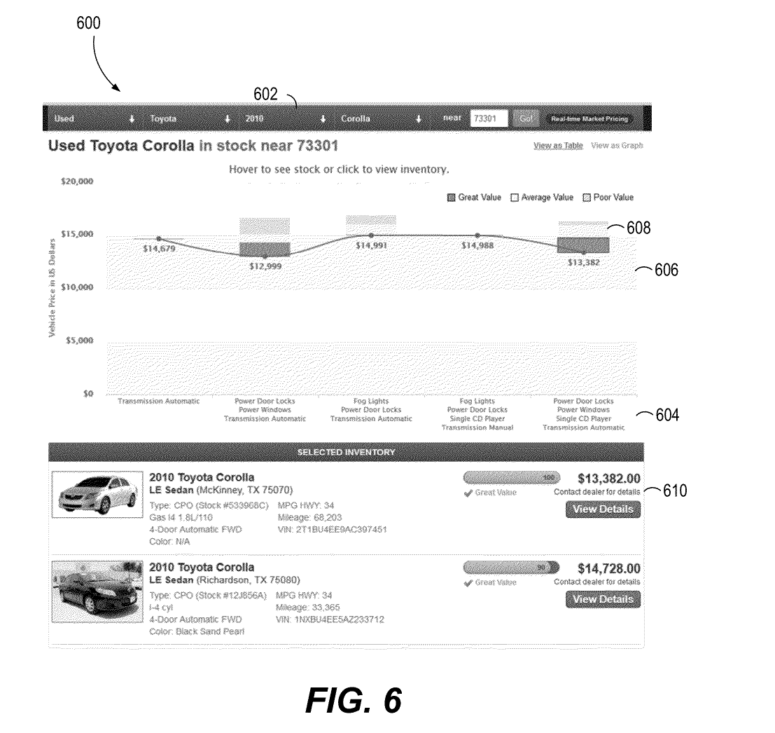

FIG. 6 shows an interface diagram of another example user interface 600 which may be generated by a vehicle pricing system. In this embodiment, the user interface may be accessed by a user in the form of a web page. This web page may be delivered over a network, such as the Internet, and may be loaded using an Internet browser. In this example user interface 600, a user has selected options from the drop-down menus 602 at the top of the interface, indicating an interest in used 2010 Toyota Corolla vehicles, near the ZIP code 73301. The example user interface 600 has thus returned a listing of 2010 Toyota Corollas within some distance of this location.

In this example user interface 600, the interface has grouped 2010 Toyota Corollas into five groups, based the features of vehicles in each group. The example user interface 600 may identify the features of the vehicles in each group in a feature bar 604. For example, vehicles in one group may have power door locks, power windows, a single CD player, and an automatic transmission. These groups of vehicles may be arranged in a particular order. For example, the groups may be arranged from the least features, on the left, to the most features, on the right. The number of groups may be determined ahead of time, or may vary depending on the number of returned vehicles and the amount of variation in the features of those vehicles. For example, the example user interface 600 may always group vehicles into a predetermined number of manageable groups, such as 2, 3, 5, 7, or 10 groups. In some embodiments, the example user interface 600 may identify features of vehicles, and determine how many groups to group vehicles into based upon the level of variation in the features of the vehicles. For example, if the example user interface 600 finds that the vehicles to be displayed vary only in one or two features, the vehicles may be grouped into a smaller number of groups, corresponding to those features. The grouping of vehicles may be predetermined, based upon certain known feature packages of certain vehicles (such as if a vehicle comes in an SX, and LX, and an SHO version), or may be customized based on the individual vehicles that will be displayed by the example user interface 600.

Organizing the returned offers into useful groups may allow a user to more easily and quickly navigate a potentially large number of offers. For example, in the example user interface 600, the interface has organized vehicles into five simple, easy-to-understand groupings. A user may be able to quickly determine which group of vehicles he or she is interested in, and to quickly narrow his or her search to those particular vehicles. The organization of offers into useful groups, including groups based upon varying feature levels and/or groups based upon the value of the price, may provide a great benefit to a user, especially when there is a large number of vehicles available for sale. Of particular note, these useful groups also avoid the user having to familiar with the major options that constitute vehicle trim designations (such as DX, LX, EX, EXL, Deluxe). The group definition abstracts the complexity of options to terminology that is not proprietary to the manufacturer.

These groups may also allow a user to quickly narrow down a potentially large list of located vehicles into a smaller number of vehicles that are of particular interest to the user. These groups may, in some instances, allow a user to more quickly locate vehicles of interest to the user, and may be easier or faster for some users than requiring that a user specify individual features that a user may desire on a vehicle. These groups may also allow a user to more quickly compare the prices of vehicles with similar features, and to determine how much money additional features may cost. These groups may also allow a huge number of choices, which a user may find intimidating or otherwise undesirable, to be narrowed down into a much more manageable number of choices. These groups may thus reduce a user's stress in deciding between a large number of options.

The feature bar 604 may be located at the bottom of a vehicle graph 606. The vehicle graph 606 may be used to indicate the price that vehicles from each group may be offered at. For example, vehicles in the furthest right group may begin at $13,382. The vehicles in each group may be further ranked according to whether they are a poor value, an average value, or a great value. This ranking may be based, at least in part, upon a relative value metric determined for each available vehicle. These categories of vehicles may be represented graphically in a stacked bar graph 608 with one or more sections. For example, if there are three tiers of relative value, the stacked bar graph 608 may contain three colored sections: a green section for great values, a yellow section for average values, and a red section for poor values. The vehicle graph 606 may allow users to easily recognize the pricing differences between various sets of features, and the range of prices which certain similar vehicles are available. The vehicle graph 606 may also provide clickable regions to allow a user to select certain groups of vehicles, or select vehicles which offer a certain value. For example, a user may be able to select vehicles in the furthest right group which offer a great value. This may allow a user to control which vehicles are shown in a vehicle listing 610.

In the example user interface 600, a user may also view a number of vehicles that are available in the vehicle listing 610. Which vehicles are listed in the vehicle listing 610 may be based, at least in part, upon the user's search and based upon the user's selections, such as selecting vehicles in the further right group which offer a great value. The vehicle listing 610 may list a variety of features each vehicle has, such as mileage, transmission type, location, make, model, and year. Each vehicle may also include a price and/or a picture. For each vehicle in the vehicle listing 610, a relative value metric may be displayed. This relative value metric may indicate whether a vehicle is a poor, average, or great value. The relative value metric may take a number of forms, such as a numeric value from 1 to 100, where 100 is the best value. One possible example of how a relative value metric may be determined is contained below, in FIG. 9.

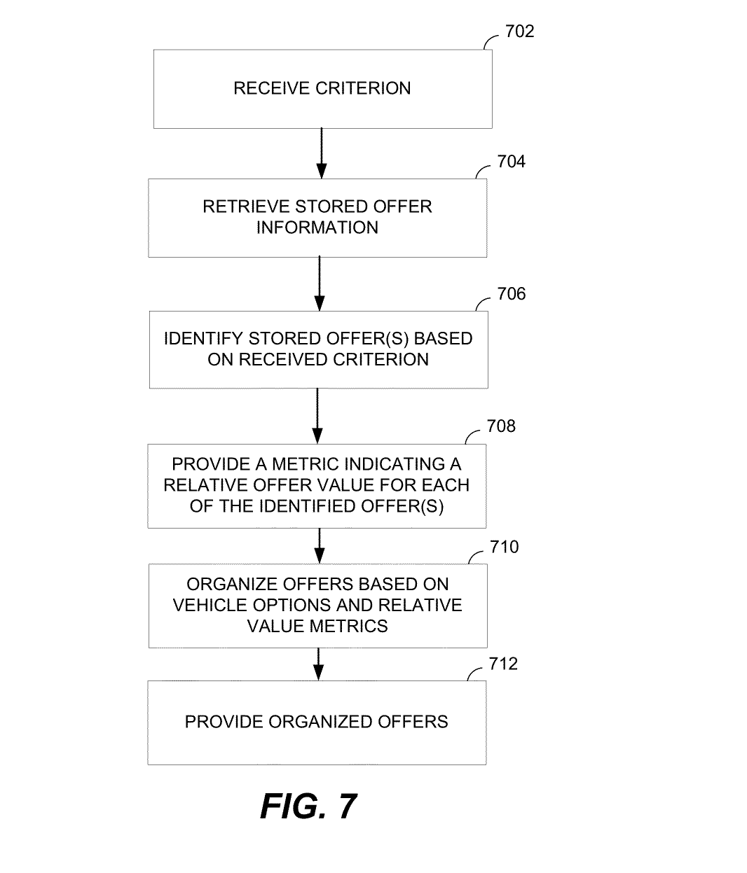

FIG. 7 shows a process flow diagram of an example of a method of displaying vehicle sale information. At block 702, criteria are received. This criterion may be received in any number of ways. For example, the criterion may be received via an electronic device over a network, such as the Internet. The criterion may be received from a user, who may transmit the criterion by interacting with a website, such as submitting a form or using drop-down menus. This criterion may include information about a certain type of vehicle. For example, this criterion may describe one or more vehicle attributes. These vehicle attributes may include year, make, model, mileage, price, transmission type, whether a vehicle is new or used, and/or where a vehicle is located. Thus, in some embodiments, the method may receive, via an electronic device, a criterion indicating a type of vehicle.

At block 704, stored offer information is retrieved. The method may access a plurality of stored offers. These offers may be stored, for example, in an electronic database that may be accessed locally or via a network. These stored offers may represent a plurality of vehicles which have been offered for sale or sold in the past. For example, these offers may include a plurality of vehicles which have been offered for sale in the United States, and which have been listed for sale on web sites. In some embodiments, the method may receive information associated with a plurality of vehicles offered for sale, which is stored in an electronic database.

At block 706, one or more stored offers are identified, based at least in part on the received criterion. The method may identify the one or more stored offers via an electronic device, such as a computer or other system. For example, if the stored offer information is kept within an electronic database, the method may use an electronic device to query the database, such that the method may identify some number of stored vehicle offers that match some or all of the received criterion. The method may also identify stored vehicle offers which are similar to some or all of the received criterion. For example, if an insufficient number of stored vehicle offers match the criterion, it may be beneficial to identify stored vehicle offers that are similar to, but not identical to, the criterion, in order to locate a larger number of stored vehicle offers. The method may apply different weights to different criteria, in determining whether a stored vehicle offer is sufficiently similar to the criterion.

At block 708, a metric indicating a relative offer value for each of the identified offers is provided. The method may provide the relative value metric via an electronic device. The relative value metric may indicate how good of a value each vehicle offer represents. For example, the relative value metric may allow a user to quickly determine whether an offer is a good value, and average value, or a poor value, without forcing the consumer to compare each vehicle offer manually. The relative value metric may be presented in any form. For example, the relative value metric may be presented as a number from 1 to 100, where 100 is the best value. The relative value metric may also be presented using descriptive words, such as describing an offer as a “poor value,” “average value,” or “great value.” The relative value metric may be determined at the time of the execution of the method, or may be stored in an electronic database or other electronic information storage system. The relative value metric may be based, at least in part, upon the identified offer and the vehicle attributes associated with the identified offer. For example, a certain type of vehicle may be grouped according to year, make, model, and features, and each vehicle within this group may be assigned a relative value metric based upon that vehicle's price and mileage relative to the prices and mileages of the other vehicles within that group. Thus, in some embodiments, the method may provide a metric indicating the relative value of each identified offer, based at least in part on vehicle attributes associate with each identified offer.

At block 710, the identified offers are organized, based at least in part on vehicle attributes and relative value metrics. The method may organize the identified offers in any number of ways. For example, the method may organize the identified offers according to one or more vehicle attributes, such as year, make, model, mileage, location, price, transmission type or other features. The method may also organize the identified offers based at least in part on their associated relative value metric. The method may sort the identified offers in an ascending or descending manner, or may sort the identified offers to display a representative subset of offers within the first few offers. The method may treat all identified offers as one large group, or may group identified offers into various smaller groups, which may impact the organization of the offers. For example, the method may sort vehicles into groups based at least in part on the features of each vehicle. For example, the method may group together vehicles which have an automatic transmission but few other optional features. The method may organize offers within each specific group according to a number of criteria, such as the relative value metric of each vehicle, vehicle location, the date at which vehicles were offered for sale, or vehicle price and features. Thus, the method may organize, via an electronic device, the identified offers based at least in part on vehicle attributes associated with each identified offer and the relative value metric of each identified offer.

Organizing the identified seller offers may be very beneficial for a user. A user may find it much easier to select vehicles when the offers for vehicles are presented organized into group, according to, for example, vehicle features and relative values. The organized offers may also be presented to a user in a visual format, which may allow a user to quickly select certain groups of vehicles. For example, the organized offers may be presented on a grid, where one axis represents the level of features on the vehicles in a useful group, and where the other axis may represent the value of each vehicle. For example, this grid may separate vehicles into five groups based upon five different levels of features on a vehicle, and may separate each of these five groups into three groups based upon whether a vehicle is a poor value, an average values, or a great value. This visual organization of offers may help a user to quickly determine which vehicles he or she may be interested in, and may help a user to sort through a large number of offers with less stress and with more confidence in his or her final selection of which vehicle to purchase. In this example, the universe of all relevant vehicles for sale has been constrained into a simple 3×5 matrix (poor, average, and great value across five natural option packages), dramatically simplifying decision making by the buyer. It will be understood that the gradient chosen to identify the value may include more or less than three classifications. Similarly, it will be understood than more or less than five groups may be used to collect the vehicles.

At block 712, the organized offers are provided. The method may provide the organized offers via an electronic device. The organized offers may be provided by an electronic device using a network (e.g., the Internet). Providing the organized offers may include formatting the organized offers into a form where a user can view them, and transmitting the organized offers to a user. For example, the user interface may take the form of a web page, transmitted via the Internet and accessed using an Internet browser. In this case, the organized offers, or a portion of the organized offers, may be placed onto one of more HTML documents in order to allow a user to view the organized offers. It may be beneficial for the method to display only a subset of the organized offers on any particular page, in order to facilitate easier browsing for a user. For example, it may be beneficial to display only 5, 10, 20, 50, or 100 offers on a particular page. The method may format the organized offers into an HTML page, or it may instead provide the organized offers to another circuit or system, in order to allow that circuit or system to format the organized offers into a more appropriate form. If the method formats the organized offers, the method may provide the formatted organized offers to a user directly, or may provide the formatted organized offers to another circuit or system, in order to provide the formatted organized offers to a user.

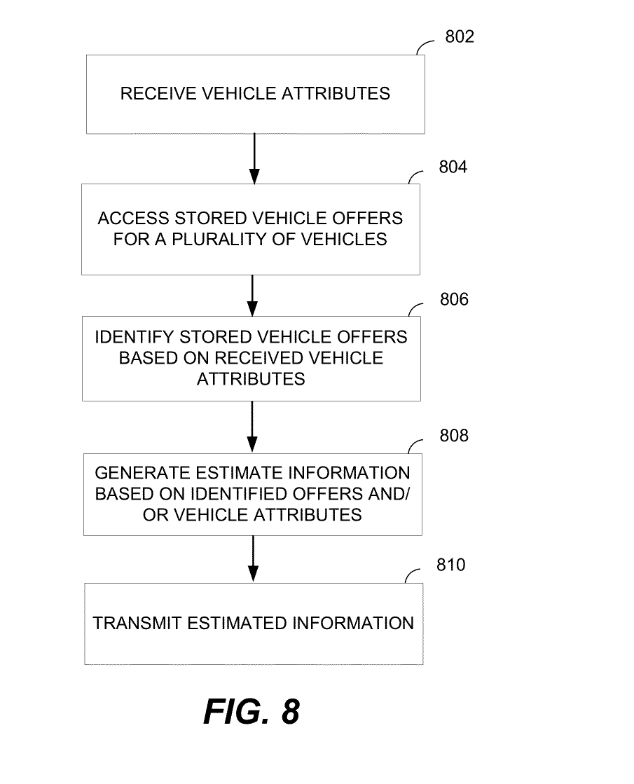

FIG. 8 shows a process flow diagram of an example of a method of pricing a vehicle. This method may be executed by an electronic device, such as a computer or other device. One example electronic device that may implement, in whole or in part, the method of FIG. 8 is shown in FIG. 2. The electronic device may be connected to one or more networks, such as a WiFi network, a local area network, or a cellular network. The electronic device may be connected to the Internet.

At block 802, vehicle attributes are received. The method may receive vehicle attributes via an electronic device, such as a computer, which may be connected to a network (e.g., a WiFi network, a local area network, and/or the Internet). The vehicle attributes may be received from a user interested in selling or determining the value of a vehicle. The vehicle attributes may be received from a website, which may allow a user to input vehicle information into a form. The vehicle attributes may include electronic data which may represent a description of a vehicle. For example, the vehicle attributes may include one or more of a vehicle year, make, model, transmission type, mileage, number of doors, location, color, and any number of other vehicle features.

At block 804, stored vehicle offers for a plurality of vehicles are accessed. The method may access stored vehicle offers using an electronic device and the vehicle offers may be stored in an electronic database. The stored vehicle offers may include information on a plurality of vehicles which have been offered for sale or sold in the past. The stored vehicle offers may include a wide variety of vehicles, and may include offers for sale from professional sellers, such as vehicle dealerships, and from other sources, such as personal sales. The stored vehicle offers may include information about sales of both new and used vehicles. The stored vehicle offers may also include information about the vehicle attributes of each vehicle offered for sale, including one or more of a vehicle year, make, model, transmission type, mileage, number of doors, location, color, price, and any number of other vehicle attributes.

At block 806, stored vehicle offers based on the received vehicle attributes are identified. The method may use an electronic device to identify the stored vehicle offers. The method may identify stored vehicle offers based on similarities between the received vehicle attributes and the vehicle attributes associated with each stored vehicle offer. For example, the method may identify stored vehicle offers that are the same year, make, and model as the received vehicle attributes. Identifying stored vehicle offers may involve querying an electronic database containing the stored vehicle offers and their associated vehicle attributes. The method may weight various vehicle attributes differently in determining which stored vehicle offers to identify. For example, the method may apply less weight to certain vehicle attributes such as vehicle color, but may apply more weight to other vehicle attributes, such as make, model, and year. The method may identify any number of stored vehicle offers. The method may also have a maximum number of vehicle offers that it will identify, such as only identifying 2, 5, 10, 50, 100 or 250 vehicle offers.

At block 808, estimate information is generated based on identified vehicle offers and/or the received vehicle attributes. The method may use an electronic device to generate estimate information based on the identified vehicle offers and/or the received vehicle attributes. The estimate information may include one or more estimates of the value of the vehicle described by the received vehicle attributes. The estimate information may include an estimate of the price that the vehicle might sell for at a dealership or at a private sale. The estimate information may be a single price, or maybe show various prices, such as prices for the vehicle to make it a poor value, an average value, or a great value. The estimate information may provide an estimate for how long it may take to sell a vehicle at a given price. The estimate information may provide one or more estimates depending on the vehicle's condition. For example, the method may return one or more estimate for a price for the vehicle if it is in excellent condition, and one or more estimate for the price for the vehicle if it is in average condition. The estimate information may be based at least in part on the vehicle attributes of the identified vehicle offers, including price, year, make, model, location and other vehicle attributes.

FIG. 9 shows a process flow diagram of an example method of determining a relative offer value for a plurality of offers. This method may be executed by an electronic device, such as a computer or other device. One example electronic device that may implement, in whole or in part, the method of FIG. 9 is shown in FIG. 2. The electronic device may be connected to one or more networks, such as a WiFi network, a local area network, or a cellular network. The electronic device may be connected to the Internet.

At block 902, a plurality of offers are organized into one or more groups. This plurality of offers may comprise a plurality of offers obtained from a storage. Each of the plurality of offers may comprise information about a vehicle that is offered for sale. This information may include the price of the vehicle, the vehicle mileage, the vehicle make, model, and year, the vehicle location, and/or information regarding any number of other qualities or characteristic about the vehicle, such as optional features and transmission type. For example, the plurality of offers may comprise a plurality of offers for a certain make, model, and year of vehicles, such as for a 2009 Toyota Corolla. Each of the plurality of offers may include the price that a 2009 Toyota Corolla is offered for sale at, the location of the vehicle, the transmission type of the vehicle, its optional features, its color, and/or any number of other characteristics of the vehicle and of the offer for sale.

The method may take this plurality of offers, and determine one or more groups, in order to organize the vehicles into a number of groups. In some embodiments, the method may choose a relatively small number of groups, such as five groups, in order to allow a user to be able to browse the selection of vehicles more easily. A user may find it much simpler to browse a large number of vehicles, if those vehicles are divided into a small number of groups, such as five, than if the vehicles are not divided into groups at all, or are divided into an excessively large number of groups, such as one thousand. The method may divide the offers into any number of groups, such as one group, two, four, five, eleven, or twenty-five groups. The method may divide the offers into a pre-determined number of groups, or may use an algorithm based upon the number of differing characteristics of the offers and/or other factors to determine the number of groups which offers should be divided into. The groups of offers may be based, at least in part, upon the number of optional features that the vehicle corresponding to each offer has. For example, the method may divide offers into groups of vehicles with similar feature levels, such as creating a group for vehicles with all optional features. The plurality of offers may be divided into a number of groups such that each offer of the plurality of offers is a member of one, but only one, group.

At block 904, each group of offers is divided into smaller subgroups based at least in part on a vehicle characteristic such as mileage. It may be beneficial to divide vehicles according to the number of miles that each vehicle has on it, as the mileage on a vehicle may be strongly correlated with the price at which a vehicle is offered for sale. The method may divide each group into any number of subgroups based on mileage. For example, the method may divide vehicles into a subgroup based upon how many miles each vehicle has, where the mileage of each vehicle is rounded to the nearest 10,000 miles. The method may use predetermined mileage levels to divide vehicles into subgroups, or may generate mileage levels for each subgroup based upon the mileages of offers contained within the plurality of offers. In some embodiments, the mileage subgroups may be comprised of vehicles with less than 10,000 miles, vehicles with 10,001 to 20,000 miles, vehicles with 20,001 to 30,000 miles, and so on.

At block 906, for at least one of each subgroup, a mean offer price for offers within that subgroup is determined. For example, the plurality of offer may comprise a plurality of offers for 2009 Toyota Corollas. These cars may be divided into groups, including a group of offers for vehicles with minimal features. This group of offers may be divided into a subgroup of offers for vehicles with between 10,001 and 20,000 miles. The method may then determine the mean price at which 2009 Toyota Corollas with minimal features and 10,001 to 20,000 miles are offered for sale. For example, the method may find that the mean price of 2009 Toyota Corollas with minimal features and 10,001 to 20,000 miles is $10,000.

At block 908, for the at least one of each subgroup, a standard deviation for the offer prices of vehicles within that subgroup is determined. For example, the method may determine the standard deviation of the prices for 2009 Toyota Corollas with 10,001-20,000 miles and with minimal features, as above. For example, the method may find that the standard deviation for the offer prices of 2009 Toyota Corollas with minimal features and 10,001 to 20,000 miles is $11,000.

At block 910, for each offer in a subgroup, the cumulative probability of the price of the offer is determined. As described above, the method may determine the mean offer price and the standard deviation for offer prices for each subgroup of offers. For example, the method may determine the mean offer price and the standard deviation of offers prices for 2009 Toyota Corollas with 10,001-20,000 miles and with minimal features, as above. The method may then use the mean price and standard deviation of offer prices, in conjunction with the offer price of a particular offer, to determine the cumulative probability of a price that is higher than a particular offer price. The method may assume a normal distribution (bell curve) in determining this cumulative probability. For example, if the method found that the mean price of 2009 Toyota Corollas with 10,001-20,000 miles and with minimal features is $10,000, and the standard deviation of offer prices is $3,000, the method may determine the cumulative probability that a particular offer price will be below the offer price of a particular 2009 Toyota Corollas with 10,001-20,000 miles and with minimal features. For example, a particular 2009 Toyota Corollas with 10,001-20,000 miles and with minimal features may be offered for sale at $7,000. In this example, the method may find that the cumulative probability of an offer of less than $7,000 is approximately 84.1%. The method may use this cumulative probability as a relative value metric score for each vehicle. This relative value metric may be formatted in a number of ways. For example, this relative value metric may be formatted as an integer between 0 and 100. In the above example, the relative value metric assigned to the particular 2009 Toyota Corolla may be “84.” Assigning a relative value metric to each vehicle may allow a user to quickly determine whether each particular vehicle is a poor deal, an average deal, or a great deal, without having to individually compare a large number of vehicles and with differing levels of features and mileages. This relative value metric may thus allow a user to be able to decide more quickly whether or not to purchase a particular vehicle, and may provide a user with more confidence that a particular price for a particular vehicle is a good value. The real-time nature of the described implementations is one in which new seller offers and/or changes in prices for existing vehicles for sale result in a revised value scoring for an entire group of cars as a whole. This provides confidence to the buyer that the value scoring reflects the state of the marketplace at the current moment in time, as compared to pricing that might be derived from prior sales transactions (e.g., days or months ago). Indeed, supply and demand can change drastically day by day, and therefore statistics based on sales transactions may be outdated by comparison.

In one implementation, the quality of the value metric may be presented along with additional value metrics for similar vehicles. In this way, the generated value metric for the selected car may be judged by the consumer as compared to additional value metrics for similar vehicles. For example, when the value metric for the 2009 Toyota Corolla is shown, a predetermined number (e.g., 1, 2, 5, or 10) of additional offers and corresponding value metrics for 2009 Toyota Corollas may be presented. The additional offers may include some offers which have a higher value metric than the selected 2009 Toyota Corolla. The additional offers may include some offers which have a lower value metric than the selected 2009 Toyota Corolla. In the case where the selected 2009 Toyota Corolla represents the highest value metric for all current offers, an indication that no better offers currently exist may be provided. Conversely, where the selected 2009 Toyota Corolla represents the lowest value metric for all current offers, an indication that no worse offers currently exist may be provided. In this way, the disclosed processes may provide real-time inventory search, real-time offer value, and real-time justification for the determined value for vehicles.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-11 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a non-transitory computer-readable medium. Computer-readable media includes both computer storage media and communication media including any medium that can be enabled to transfer a computer program from one place to another. A storage media may be any available media that may be accessed by a computer. By way of example, and not limitation, such computer-readable storage media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of displaying vehicle pricing information comprising:
receiving, via an electronic device, a criterion indicating a type of vehicle;
storing, in an electronic database, information associated with a plurality of vehicles offered for sale;
identifying, via the electronic device, one or more offers of the plurality of vehicles offered for sale based at least in part on the criterion;
providing, via the electronic device, a metric indicating a relative value of each of the identified offers based at least in part on vehicle attributes associated with each identified offer;
organizing, via the electronic device, the identified offers based at least in part on vehicle attributes associated with each identified offer and the metric indicating the relative value of each identified offer; and
providing, via the electronic device, the organized offers.

2. The method of claim 1, further comprising:
communicating, via the electronic device, with a vehicle selling forum;
collecting, via the electronic device, an offer from the vehicle selling forum;
extracting, via the electronic device, vehicle attributes associated with the collected offer;
identifying, via the electronic device, one or more comparison offers of the plurality of vehicles offered for sale based at least in part on the vehicle attributes associated with the collected offer;
generating a metric indicating a relative value of the collected offer as compared to the identified comparison offers, based at least in part on vehicle attributes associated with the collected offer and the identified comparison offers.

3. The method of claim 1, wherein providing a metric indicating a relative value of each of the identified offers comprises generating a metric indicating a relative value of each of the identified offers as compared to other identified offers, based at least in part on vehicle attributes associated with each identified offer.

4. The method of claim 3, wherein generating a metric comprises generating the metric indicating a relative value of each of the identified offers as compared to other identified offers based at least in part on one or more of a vehicle identification number, a vehicle make, a vehicle model year, a vehicle option, a mileage associated with the vehicle, an offer price, a date of offer, and a location associated with each offer.

5. The method of claim 1, wherein the criterion includes at least one of a location indicator, a model year, a manufacturer, a model, and a mileage.

6. The method of claim 1, wherein the vehicle attributes includes at least one of a location indicator, a model year, a manufacturer, a model, and a mileage.

7. The method of claim 1, wherein identifying one or more vehicle offers comprises:
comparing one or more vehicle attributes provided in the criterion with a one or more vehicle attributes associated with a vehicle offered for sale; and
positively identifying the vehicle offered for sale based on a result of the comparison.

8. The method of claim 5, wherein comparing comprises determining if the one or more vehicle attributes provided in the criterion is the same as the one or more vehicle attributes associated with a vehicle offered for sale.

9. The method of claim 5, wherein comparing comprises determining if a difference between one or more vehicle attributes provided in the criterion and one or more vehicle attributes associated with a vehicle offered for sale is less than a configurable difference tolerance value.

10. The method of claim 1, wherein organizing the offers comprises generating one or more signals including the vehicle options associated with one or more identified offers and the metric indicating the relative value of the one or more identified offers.

11. A system for displaying vehicle pricing information comprising:
a database storing information associated with a plurality of vehicles offered for sale;
a receiver configured to receive a criterion indicating a type of vehicle;
an identification circuit configured to identify one or more offers of the plurality of vehicle offered for sale based at least in part on the criterion;
an organizing circuit configured to organize the identified offers based on vehicle attributes associated with each vehicle offered for sale and a metric indicating a relative value of the vehicle offered for sale as compared to other identified offers; and
a transmitter configured to transmit the organized offers based on groups of vehicle attributes and groups of relative offer values.

12. The system of claim 11, wherein the criterion includes at least one of a location indicator, a model year, a manufacturer, a model, and a mileage.

13. The system of claim 11, wherein the identification circuit is configured to:
compare a value provided in the criterion with a value associated with an offer; and
positively identify the offer based on a result of the comparison.

14. The system of claim 13, wherein comparing comprises determining if the value provided in the criterion is the same as the value associated with an offer.

15. The system of claim 13, wherein comparing comprises determining if a difference between the value provided in the criterion and the value associated with an offer is less than a configurable difference tolerance value.

16. The system of claim 13, wherein comparing comprises comparing a portion of the value provided in the criterion with a portion of the value associated with an offer.

17. The system of claim 11, wherein organizing the offers comprises generating one or more signals including the offer information, the associated option categorization, and the relative offer value.

18. The system of claim 11, further comprising generating the metric indicating a relative value of the offer as compared to other identified offers based at least in part on one or more of a vehicle identification number, a vehicle make, a vehicle model year, a vehicle option, a mileage associated with the vehicle, an offer price, a date of offer, and a location associated with each offer.

19. A method of displaying vehicle pricing information comprising:
receiving, via an electronic device, a criterion indicating a type of vehicle;
storing, in an electronic database, information associated with a plurality of vehicles offered for sale;
identifying, via the electronic device, an offer of the plurality of vehicle offered for sale based at least in part on the criterion and a relative value of the offer as compared to other identified offers; and
providing, via the electronic device, the offer.

20. The method of claim 19, wherein the criterion includes at least one of a location indicator, a model year, a manufacturer, a model, and a mileage.

21. The method of claim 19, wherein identifying the offer comprises:
obtaining a set of offers based on a comparison of a value provided in the criterion with a value associated with an offer of the plurality of offers;
determining a relative value for each offer in the set of offers; and
positively identifying the offer associated with the highest determined relative value.

22. The method of claim 21, wherein comparing comprises determining if the value provided in the criterion is the same as the value associated with an offer.

23. The method of claim 21, wherein comparing comprises determining if a difference between the value provided in the criterion and the value associated with an offer is less than a configurable difference tolerance value.

24. The method of claim 21, wherein comparing comprises comparing a portion of the value provided in the criterion with a portion of the value associated with an offer.

25. The method of claim 19, wherein organizing the offers comprises generating one or more signals including the offer information, the associated option categorization, and the relative offer value.

26. A system for displaying vehicle sale information comprising:
a database storing information associated with a plurality of vehicles offered for sale;
a receiver configured to receive a criterion indicating a type of vehicle;
an identification circuit configured to identify an offer of the plurality of vehicles offered for sale based at least in part on the criterion and a relative value of the offer as compared to other identified offers; and
a transmitter configured to transmit the offer.

27. The system of claim 26, wherein the criterion includes at least one of a location indicator, a model year, a manufacturer, a model, and a mileage.

28. The system of claim 26, wherein the identification circuit is configured to:
obtain a set of offers based on a comparison of a value provided in the criterion with a value associated with an offer of the plurality of vehicles offered for sale;
determine a relative value for each offer in the set of offers; and
positively identify the offer associated with the highest determined relative value.

29. The system of claim 28, wherein comparing comprises determining if the value provided in the criterion is the same as the value associated with an offer.

30. The system of claim 28, wherein comparing comprises determining if a difference between the value provided in the criterion and the value associated with an offer is less than a configurable difference tolerance value.

31. The system of claim 28, wherein comparing comprises comparing a portion of the value provided in the criterion with a portion of the value associated with an offer.

32. The system of claim 26, wherein organizing the offers comprises generating one or more signals including the offer information, the associated option categorization, and the relative offer value.

33. A method of selling a vehicle, the method comprising:
receiving, via an electronic device, an attribute of a vehicle;
storing, in an electronic database, information associated with a plurality of vehicles offered for sale;
identifying, via the electronic device, one or more offers of the plurality of vehicles offered for sale based on the received attribute;
generating, via the electronic device, an estimated sale price based on the identified offers; and
transmitting, via the electronic device, the estimated sale price.

34. The method of claim 33, the method further comprising receiving another attribute of the vehicle, wherein identifying one or more offers is further based on the other attribute of the vehicle.

35. The method of claim 33, wherein the attribute includes at least one of a location indicator, a model year, a manufacturer, a model, and a mileage.

36. The method of claim 33, the method further comprising:
generating, via the electronic device, an estimated time to sell a vehicle with the identified attribute based on the identified offers; and
transmitting, via the electronic device, the estimated time to sell.

37. The method of claim 33, further comprising transmitting information associated with the one or more identified offers upon which the estimated sale price is based.

38. The method of claim 37, wherein the information associated with the one or more identified offers includes one or more of a number of identified offers, a total number of offers stored, a number of current offers, and an average age of the identified offers.

39. A system for selling a vehicle, the system comprising:
a receiver configured to receive an attribute of a vehicle;
a storage including information associated with a plurality of vehicles offered for sale;
an identification circuit configured to identify one or more offers of the plurality of vehicles offered for sale based on the received attribute;
a valuation circuit configured to generate an estimated sale price based on the identified offers; and
a transmitter configured to transmit the estimated sale price.

40. The system of claim 39, wherein the receiver is configured to receive another attribute of the vehicle, and wherein identifying one or more offers is further based on the other attribute of the vehicle.

41. The system of claim 39, wherein the attribute includes at least one of a location indicator, a model year, a manufacturer, a model, and a mileage.

42. The system of claim 39, the system further comprising a sale time estimating circuit configured to estimate a time to sell a vehicle with the received attribute based on the identified offers, the transmitter further configured to transmit the estimated time.

43. The system of claim 39, further comprising transmitting information associated with the one or more identified offers upon which the estimated sale price is based.

44. The system of claim 43, wherein the information associated with the one or more identified offers includes one or more of a number of identified offers, a total number of offers stored, a number of current offers, and an average age of the identified offers.

45. A method of selling a vehicle, the method comprising:
receiving, via an electronic device, an attribute of a vehicle and a price;
storing, in an electronic database, information associated with a plurality of vehicles offered for sale;
identifying, via the electronic device, one or more offers of the plurality of vehicles offered for sale based on the received attribute;
generating, via the electronic device, a value indicating a relative quality of the offered vehicle as compared with the identified offers; and
transmitting, via the electronic device, the relative value of the offer.

46. The method of claim 45, the method further comprising receiving another attribute of the vehicle, wherein identifying one or more offers is further based on the other attribute of the vehicle.

47. The method of claim 45, wherein the attribute includes at least one of a location indicator, a model year, a manufacturer, a model, and a mileage.

48. The method of claim 45, the method further comprising:
generating, via the electronic device, an estimated time to sell based on the identified offers; and
transmitting, via the electronic device, the estimated time to sell.

49. A system for selling a vehicle, the system comprising:
a receiver configured to receive an attribute of a vehicle and a price;
a storage including information associated with a plurality of vehicles offered for sale;
an identification circuit configured to identify one or more offers of the plurality of vehicles offered for sale based on the received attribute;
a valuation circuit configured to generate a value indicating a relative quality of the offered vehicle as compared with the identified offers; and
a transmitter configured to transmit the relative value of the offer.

50. The system of claim 49, wherein the receiver is configured to receive another attribute of the vehicle, and wherein identifying one or more offers is further based on the other attribute of the vehicle.

51. The system of claim 49, wherein the attribute includes at least one of a location indicator, a model year, a manufacturer, a model, and a mileage.

52. The system of claim 49, the system further comprising a sale time estimating circuit configured to estimate a time to sell a vehicle with the received attribute based on the identified offers, the transmitter further configured to transmit the estimated time.
